(19) United States
(12) Patent Application Publication
(10) Pub. No.: US 2002/0147260 A1
(43) Pub. Date: Oct. 10, 2002

(54) Ethylene-propylene copolymer rubber compositions

(76) Inventors: Hideo Harada, Okazaki-city (JP); Arata Iida, Anjo-city (JP); Shinichi Inagaki, Kasugai-city (JP)

Correspondence Address: HARNESS, DICKEY & PIERCE, P.L.C., P.O. BOX 828, BLOOMFIELD HILLS, MI, 48303, US

(21) Appl. No.: 10/027,711

(22) Filed: Dec. 19, 2001

(30) Foreign Application Priority Data
Jan. 23, 2001 (JP) 2001-15061

(51) Int. Cl. C08K 3/34; C08F 210/00

(52) U.S. Cl. 524/451; 526/348

(57) ABSTRACT

An ethylene-propylene copolymer rubber (EP rubber) composition is usable as a molded rubber product having freon-gas barrier properties. The EP rubber composition is an organic peroxide vulcanizable (crosslinkable) type having, as a base, a rubber polymer containing an EP rubber of an amount of at least 30 wt. % in the whole rubber polymer. In addition, the EP rubber has a Mooney viscosity (ML₁₊₄, 100° C.) of about 50 or greater.

### CROSS-REFERENCE TO RELATED APPLICATION

This application is related to and claims priority from Japanese Patent Application No. 2001-15061 filed on Jan. 23, 2001, the contents of which are hereby incorporated by reference.

### BACKGROUND OF THE INVENTION

1. Field of the Invention

The present invention relates to ethylene-propylene copolymer rubber (which will hereinafter be abbreviated as “EP rubber”) compositions. More specifically, the invention relates to EP rubber compositions usable as a molded rubber product having gas barrier properties against freon gas. The EP rubber compositions are organic peroxide vulcanizable (crosslinkable) type having, as a base, a rubber polymer containing at least 30 wt. % of the EP rubber in the whole rubber components (rubber polymer).

2. Description of the Related Art

In recent years, control on use or emission of various chemical substances has been studied and carried out from the viewpoint of environmental protection for the earth. With regards to refrigerants for a refrigeration cycle used for a refrigerator system such as a vehicle air conditioner, Freon R-12 (CFCs) and Freon R-134a (HFCs) are regarded as green house gases and they are presumed to be regulated more severely in near future.

Reflecting a request for extending the life cycle of an air conditioner, an investigation on a sealant (sealing member) having gas barrier properties has been made for preventing leakage of the above-described refrigerant outside of a refrigerator system. For the sealing members (O-rings, packings, etc.) of the refrigerant, NBR (mainly, hydrogenated NBR) materials are usually employed. For example, a rubber composition as described in JP-A-9-77911 is known as an organic peroxide vulcanizable type rubber composition composed of hydrogenated NBR and EP rubber.

According to the patent gazette, when “Freon R-12” or “Freon R-134a” is used as a refrigerant, a molded rubber product made of this rubber composition does not generate blisters even under high temperature conditions. The term “blisters” as used herein means swellings and cracks appearing on the surface of a sealant (rubber material) upon rapid evaporation of a freon gas absorbed inside of the sealant (rubber material) under the high temperature conditions. The rubber polymer of the hydrogenated NBR composition as described in the above-described patent gazette contains at least 55 wt. % of hydrogenated NBR, meaning that it is a composition consisting of more hydrogenated NBR and less EP rubber. Here, a “Freon R134a” gas is blown to a rubber film, and gas barrier properties are evaluated based on its amount passing through the rubber film. However, when the “Freon R134a” is sealed in a refrigeration cycle and an amount of this gas passing through sealing members of an actual device model is measured, it is difficult to have sufficient gas barrier properties against a freon gas while restricting generation of blisters.

### SUMMARY OF THE INVENTION

In view of the foregoing problem, it is an object of the present invention to provide an EP rubber composition having sufficient gas barrier properties against a freon gas, being almost free from generation of blisters and permitting production of excellent molded rubber products.

It is another object of the present invention to provide an EP rubber composition exhibiting small swelling properties when in contact with a mineral oil and permitting production of molded rubber products (vulcanizates) having a good compression set characteristic.

According to the present invention, in an ethylene-propylene copolymer rubber (EP rubber) composition usable as a molded rubber product having freon-gas barrier properties, the EP rubber composition is an organic peroxide vulcanizable (crosslinkable) type having, as a base, a rubber polymer containing an EP rubber of an amount of at least 30 wt. % in the whole rubber polymer. In addition, the EP rubber has a Mooney viscosity (ML₁₊₄, 100° C.) of about 50 or greater, preferably, about 55 or greater. Accordingly, swelling properties when in contact with a mineral oil can be made smaller, and production of molded rubber products (vulcanizates) has a good compression set characteristic.

Preferably, the rubber polymer contains an NBR rubber, so that a weight ratio of NBR rubber/EP rubber is in a range of about from 10/90 to about 70/30. More preferably, the weight ratio of NBR rubber/EP rubber is in a range of from about 20/80 to about 60/40. Accordingly, even when a rubber product made of the EP rubber composition is used in a freon gas, sufficient gas barrier properties can be obtained, and generation of blisters can be sufficiently restricted.

### BRIEF DESCRIPTION OF THE DRAWINGS

Additional objects and advantages of the present invention will be more readily apparent from the following detailed description of a preferred embodiment when taken together with the accompanying drawings, in which:

FIG. 1 is a schematic diagram illustrating a structure of a refrigerator in which an O-ring made of an EP rubber composition of the present invention is usable; and

FIG. 2 is a cross-sectional schematic diagram of a joint of refrigerant pipes of the refrigerator in FIG. 1.

### DETAILED DESCRIPTION OF THE PREFERRED EMBODIMENT

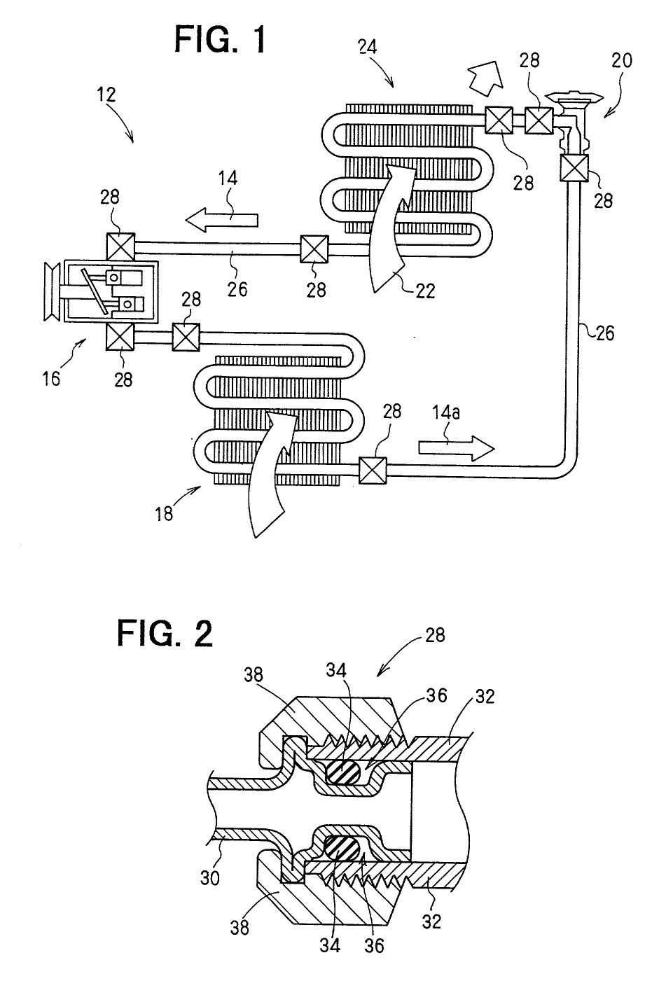

A description will hereinafter be made of the EP rubber composition of the present invention used for an O-ring disposed at a joint of refrigerant pipes of a refrigerator. FIG. 1 shows a refrigerator 12 having an O-ring made of the EP rubber composition of the present invention.

The refrigerator 12 includes a compressor 16 for compressing a refrigerant gas 14, a condenser 18 for liquefying and condensing the compressed refrigerant gas 14, a pressure-reducing valve 20 for pressure-reducing and spraying the liquefied refrigerant 14a, an evaporator 24 for evaporating the liquefied refrigerant 14a into a refrigerant gas and for cooling the air 22 by making use of the heat of vaporization of the refrigerant, and refrigerant pipes 26 for connecting those components. The above-described refrigerant pipes 26 are connected with the compressor 16, the condenser 18, the pressure-reducing valve 20 and the evaporator 24 via joint portions 28, each of which is as illustrated in FIG. 2.

The joint portion 28 of FIG. 2 includes a male joint 30 and a female joint 32, and an O-ring 34 is disposed between the male joint 30 and the female joint 32. The male joint 30 has, at its outer periphery, a fixing groove 36 for fixing the O-ring 34. When the male joint 30 is inserted into the female joint 32, the O-ring 34 is compressed between the male joint 30 and the female joint 32, thereby sealing the space between the male joint 30 and the female joint 32. A nut 38 is disposed at an outer periphery of the male joint 30 and the female joint 32 to fix them.

The above-described O-ring 34 has gas barrier properties against a freon gas (flon gas). The O-ring 34 is made of an organic peroxide vulcanizable type EP rubber composition having, as a base, a rubber polymer containing at least 30 wt. % of an EP rubber in the whole rubber component. As the above-described rubber polymer, any rubber polymer containing at least 30 wt. % of an EP rubber may be used. For example, it includes a rubber polymer composed 100% of an EP rubber (that is, composed alone of an EP rubber). The rubber polymer containing at least 30 wt. % of an EP rubber is used, because gas barrier properties against Freon R-134a becomes lower and a compression set becomes larger when the EP rubber contents less than 30 wt. %. Accordingly, in this case, the sealing life of the O-ring 34 is affected. Long sealing life is available when a molded rubber product has a compression set adjusted to 40% or less.

As the EP rubber, any one of ethylene-propylene copolymer rubber and ethylene-propylene-diene copolymer rubbers (EPDM) containing an another third component may be used. Among them, commercially available EP rubbers containing from about 60% to about 80% of an ethylene unit are preferred, because they have excellent rubber characteristics and make it possible to prevent generation of blisters which will otherwise occur in their molded products. EPDM, containing dicyclopentadiene (CDPD) or ethylidene norbornene (ENB) as the third component is particularly preferred for excellent sealing life of the O-ring 34. The third component (CDPD, ENB) is preferably added to EPDM by an amount of at least about 5 wt. %, more preferably, at least about 5.5 wt. %, relative to the EPDM. When the content of the third component is less than 5 wt. %, blisters readily cause in the O-ring when Freon R-12 is used as a refrigerant.

The upper limit of the content of the third component of EPDMs commercially available now is about 9 wt. %. The present inventors have confirmed that EPDMs containing from about 5 wt. % to about 9 wt. % of the third component can be employed in the present invention. It is presumed that even if EPDMs containing the third component by an amount of 9 wt. % or greater are put on the market in future, they will be usable as the EP rubber of the present invention.

In the EP rubber, a Mooney viscosity (ML₁₊₄, 100° C.) is about 50 or greater, preferably, is about 55 or greater, because at such a value, a favorable compression set of the O-ring can be maintained and sealing life can be extended. When the Mooney viscosity is lower than the above-described range, the O-ring 34 swells markedly when contacting a lubricating oil (mineral oil) charged in a system. In this case, the O-ring may protrude, and its sealing life may be decreased.

The upper limit of the Mooney viscosity (ML₁₊₄, 100° C.) of the EP rubbers commercially available now is about 105. The present inventors have confirmed that EP rubbers having a Mooney viscosity of from about 50 to about 105 can be employed in the present invention. It is presumed that even if EP rubbers having a Mooney viscosity of about 105 or greater are put on the market in future, they will be usable as the EP rubber of the present invention.

The above-described rubber polymer is preferred to contain an NBR rubber as a component other than the EP rubber. In other words, the above-described O-ring is preferably a molded or formed product obtained by crosslinking a rubber polymer composed of an EP rubber and an NBR rubber with an organic peroxide. As the NBR rubber, either one of NBR or hydrogenated NBR may be used. A mixture of them is also usable.

As NBR, usable is a copolymer rubber of acrylonitrile and butadiene, preferably a copolymer rubber of from 30% to 50% of acrylonitrile and from 70% to 50% of butadiene. On the other hand, the hydrogenated NBR is obtained by hydrogenating the above-described NBR to decrease its carbon-carbon double bond content in a molecular backbone to 50% or less (hydrogenation degree: exceeding 50%), preferably 30% or less (hydrogenation degree: exceeding 70%), more preferably 10% or less (hydrogenation degree: exceeding 90%). More specifically, commercially available products such as “Zetpol” of Zeon Corporation are usable.

A weight ratio of the hydrogenated NBR to the EP rubber in the rubber polymer made of the hydrogenated NBR and the EP rubber is set at from about 10/90 to about 70/30, preferably from about 20/80 to about 60/40. In the present invention, a ratio of the EP rubber in the EP rubber composition is different from that in the known technique in order to decrease the permeation of a freon gas in a refrigerator system.

In Japan, not a mineral oil but a polyalkylene glycol (PAG) oil is ordinarily used as a lubricating oil in a Freon R-134a refrigerator system. PAG has only a small influence on physical properties of rubber even if it contact an EP rubber material. There is however a possibility of use of an oil other than PAG (particularly, mineral oil) by mistake after shipping. Therefore, swelling of a rubber material when contacting a mineral oil must also be taken into consideration.

Foaming under high temperature conditions presumably occurs when Freon R-12 is used by mistake as a refrigerator system, particularly in foreign countries, though this is not a usual case. When the content of an NBR rubber is too small, gas barrier properties against Freon R-12 becomes lower, causing marked swellings of a rubber material in a mineral oil. When the content of an EP rubber is too small, on the other hand, gas barrier properties against Freon R-134a becomes lower and the compression set increases, thereby having a bad influence on the sealing life of the O-ring 34.

These rubber polymers are usually crosslinked using an organic peroxide of an amount of about 1 to 10 parts by weight, preferably about 2 to 8 parts by weight, relative to 100 weight parts of the rubber polymers. For example, the organic peroxide includes di-tert-butyl peroxide, dicumyl peroxide, tert-butyl-cumyl peroxide, 1,1-di(tert-butylperoxy)-3,3,5-trimethylcyclohexane, 2,5-dimethyl-2,5di(tert-butylperoxy) hexane, 2,5-dimethyl-2,5-di(tert-butylperoxy)hexyne-3,1,3-di(tert-butyl-peroxyisopropyl) benzene, 2,5-dimethyl-2,5-di(benzoylperoxy)hexane, tert-butylperoxy benzoate, tert-butylperoxy isopropylcarbonate and n-butyl-4,4-di(tert-butylperoxy)valerate.

In addition to the above-described essential components, additives ordinarily employed in the rubber industry are incorporated in the rubber composition as needed. For example, the additives include polyfunctional compounds such as triallyl(iso)cyanurate, trimethylolpropane trimethacrylate, and triallyl trimellitate; fillers such as carbon black, silica, talc, mica, clay, graphite and calcium carbonate, processing aids such as stearic acid, palmitic acid and paraffin wax; acid acceptors such as magnesium oxide, hydrotalcite and epoxy resins; antioxidants and plasticizers. These additives may be added in a normal using amount.

As the filler, a biaxially oriented plate-like (flat) filler is preferably used, among fillers of various particulate shapes such as non-orientation type (amorphous, spherical, cubic, and the like), uniaxial orientation type (spindle-like, needle-shaped, columnar, fibrous and the like) and biaxial orientation type (plate-shaped filler including scaly and leafy type). Selection of this plate-like filler makes it possible to suppress the permeation amount of a freon gas, because diffusion of the freon gas in the rubber can be detoured by this filler in the molded rubber product of the resulting composition.

For example, the plate-like filler includes talc, mica and graphite. The plate-like filler preferably has an average particle size of from about 0.1 to about 100 μm, desirably, 1 to 10 μm. Excessively large average particle sizes do not bring about effects for reducing the permeation amount of a freon gas, while excessively small average particle sizes deteriorate dispersibility of the filler upon kneading.

The plate-like filler is added by an amount of from about 30 to about 150 weight parts, relative to 100 weight parts of a rubber polymer. Excessively small amounts of the plate-like filler deteriorate effects for reducing the permeation amount of a freon gas. Conversely, excessively large amounts of the plate-like filler deteriorate the processing properties of the composition as a sealant.

An O-ring made of an EP rubber having a Mooney viscosity of 50 or greater has usually a low extension ratio, and may cause fracture (breakage) upon attachment in an extended state. In the present invention, it is therefore preferred to use, as an additive, a reinforcing filler (reinforcing agent) in combination with the above-described plate-like filler to maintain an extension ratio. Preferred examples of the reinforcing filler (reinforcing agent) include carbon black, silica, clay and calcium carbonate. These reinforcing fillers may be used either singly or in combination. The reinforcing filler is added as fine powder by an amount of about 1 to 80 weight parts, preferably about 10 to 70 weight parts, relative to 100 weight parts of the rubber polymer. As silica, any one of silicic anhydride, hydrous silicic acid, calcium silicate and aluminum silicate may be employed.

By the combined use of the plate-like filler and reinforcing filler as described above, both the effects of the plate-like filler for reducing a permeation amount of a freon gas and reinforcing effects of the reinforcing filler can be obtained, thereby it is possible to obtain a rubber composition more suited as a sealant.

The rubber composition is prepared by kneading in a kneader such as an intermixer, a kneader or a Banbury mixer or in an open roll mill. Vulcanization is performed by heating, usually, at between 150 and 200° C. for from about 3 to about 60 minutes using an injection molder, a compressing molding press or a vulcanizing press. If necessary, secondary vulcanization is conducted at from about 120° C. to about 200° C. for about 1 to 24 hours as needed.

The obtained EP rubber vulcanizate is suited for use as an O-ring for freon refrigerant when it has a hardness of 70 or greater, preferably 72 or greater in a durometer hardness test (JIS K 6253: Type A).

The above-described constitution of the present invention makes it possible to decrease the amount of a hydrogenated NBR as compared with that of the known technique, and to provide a rubber composition composed mainly of an EP rubber. Therefore, the using amount of expensive hydrogenated NBR can be reduced. In other words, in the present invention, it is possible to decrease the content of hydrogenated NBR in an EP rubber composition, leading to a reduction in the production cost of an EP rubber composition. The present invention therefore has an economic contribution.

As described above, any one of Freon R-12 or Freon R-134a is usable as a refrigerant for a refrigerator in which an O-ring made of the EP rubber composition of the present invention is used. Accordingly, it is possible to save a labor for attaching a different sealant in accordance with the kind of a refrigerant. In addition, the invention composition can also be used for a refrigerator system in which a mineral oil uses as a lubricating oil.

According to the present invention, the EP rubber composition is an organic peroxide vulcanizable (crosslinkable) type having, as a base, a rubber polymer containing an EP rubber of an amount of at least 30 wt. % in the whole rubber polymer. In addition, the EP rubber has a Mooney viscosity (ML₁₊₄, 100° C.) of about 50 or greater, preferably, about 55 or greater. Accordingly, swelling properties when in contact with a mineral oil can be made smaller, and production of molded rubber products (vulcanizates) has a good compression characteristic.

A description will next be made of Present Examples conducted to confirm the effects of the present invention. In the Present Examples and Comparative Examples, the following products are used:

Hydrogenated NBR: “Zetpol 2010”, product of Zeon Corporation.

EPDM1: “EPT 4070H”, product of Mitsui Chemicals (wherein, ML₁₊₄ (100° C.): 69, ethylidene norbornene: 8.0 wt. %).

EPDM2: “EPT 3045H”, product of Mitsui Chemicals (wherein, ML₁₊₄ (100° C.): 40, ethylidene norbornene: 4.5 wt. %).

EPDM3: “EP 75F”, product of JSR (wherein, ML₁₊₄ (100° C.): 85, dicyclopentadiene: 7.8 wt. %).

EPDM4: “EPT 1070H”, product of Mitsui Chemicals (wherein, ML₁₊₄ (100° C.): 67, dicyclopentadiene: 4.0 wt. %).

Organic peroxide: “Perbutyl P (100%)”, product of NOF Corporation.

Carbon black (reinforcing filler): “SEAST S”, product of Tokai Carbon Co., Ltd.

Silica (reinforcing filler): “Nipsil VN₃”, product of Nippon Silica Industrial Co., Ltd.

Talc (plate-like filler): “Mistron 850JS”, product of Nippon Mistron Co., Ltd.

Antioxidant: “Nocrac CD”, product of Ouchi Shinko Chemical Industrial Co., Ltd.

Silane coupling agent: “A-172”, product of Nippon Unicar Co., Ltd.

After kneading of the above-described materials by using a kneader and a roll, the kneaded mass is subjected to press vulcanization (primary vulcanization) at 180° C. for 5 minutes. Then, oven vulcanization (secondary vulcanization) at 160° C. for 5.5 hours is conducted, whereby an O-ring having a wire diameter of 2.4 mm is obtained.

Basic formulation of each of Present Examples and Comparative Examples is as follows:

### Basic Formulation of EP Rubber Compositions

| | |
|---|---|
| Rubber polymer | 100 wt. % |
| Organic peroxide | 4 wt. % |
| Carbon black | 40 wt. % |
| Silica | 21 wt. % |

(used in examples other than Present Example 12)

| | |
|---|---|
| Talc | 70 wt. % |

(used only in Present Example 12)

| | |
|---|---|
| Antioxidant | 1 wt. % |
| Silane coupling agent | 1 wt. % |

(The composition of the rubber polymer differs with examples.)

Physical properties of rubber compositions are obtained in the Present Examples and the Comparative Examples while changing their kind or formulation are evaluated. The results are shown in Tables 1 to 3. In each of present Examples and the Comparative Examples, hardness (type A), tensile strength (MPa) and elongation (%) in the ordinary state are measured and compared. In addition, a volumetric change (%) in each of polyalkylene glycol and mineral oil and a compression set are measured and compared. Generation of blisters when each of Freon R-134a and Freon R-12 is used is studied and results are compared. Further, a permeation amount of Freon R-134a is measured. In the item concerning blisters in Tables 1, 2 and 3, the polymer free from blisters is indicated by “◯” the polymer generating blisters too small to be visually observed is indicated by “Δ”, and the polymer generating blisters large enough to be visually observed is indicated by “X”.

TABLE 1

| | | Comp. Ex. | Pres. | Pres. | Pres. | Pres. |
|---|---|---|---|---|---|---|
| | | 1 | Ex. 1 | Ex. 2 | Ex. 3 | Ex. 4 |
| Polymer | | Hydrogenated | EPDM1 | EPDM2 | EPDM3 | EPDM4 |
| | | NBR | | | | |
| Ordinary | Hardness | 80 | 81 | 80 | 81 | 78 |
| state | (type A) | | | | | |
| | Tensile | 33.3 | 12.6 | 18.6 | 17.6 | 13.7 |
| | strength | | | | | |
| | (MPa) | | | | | |
| | Elongation | 260 | 150 | 195 | 165 | 180 |
| | (%) | | | | | |
| Volumetric | Polyalkylene | 4.4 | 6.1 | 6.1 | 6.2 | 6.6 |
| change (%) | glycol (%) | | | | | |
| | Mineral oil | 2.1 | 54.8 | 71.6 | 57.9 | 74.6 |
| | (%) | | | | | |
| Compression set (%) | | 42.2 | 19.8 | 28.7 | 20.1 | 24.3 |
| Blisters | Freon R-134a | × | ◯ | ◯ | ◯ | ◯ |
| | Freon R-12 | ◯ | ◯ | × | ◯ | × |

| | | | | | |
|---|---|---|---|---|---|
| Permeation amount of | 0.23 | 0.10 | 0.12 | 0.11 | 0.11 |
| Freon R-134a (mg/cm² · h) | | | | | |

◯: without blisters
Δ: existence of blisters too small to be visually observed
×: existence of blisters large enough to be visually observed

In Table 1, rubber compositions contain, as a rubber polymer, only EPDM but are different in the kind of EPDM. It has been understood that compared with the composition of Comparative Example 1 for which only hydrogenated NBR is used as a rubber polymer, the compositions of Present Examples did not generate blisters when Freon R-134a is used, and has excellent gas barrier properties. This means that the compositions of the Present Examples are more suitable under an ordinary refrigerator system (wherein Freon R-134a is used and a non-mineral oil is used).

TABLE 2

| | | Pres. | Pres. | Pres. | Pres. | Pres. | Comp. | Comp. |
|---|---|---|---|---|---|---|---|---|
| | | Ex. 1 | Ex. 5 | Ex. 6 | Ex. 7 | Ex. 8 | Ex. 2 | Ex. 1 |
| Polymer | Hydrogenated | — | 20 | 30 | 40 | 60 | 80 | 100 |
| | NBR | | | | | | | |
| | (Wt. %) | | | | | | | |
| | EPDM1 | 100 | 80 | 70 | 60 | 40 | 20 | — |
| | (Wt. %) | | | | | | | |
| Ordinary | Hardness | 81 | 82 | 82 | 83 | 82 | 81 | 80 |
| state | (type A) | | | | | | | |
| | Tensile | 12.6 | 12.6 | 13.0 | 13.5 | 16.0 | 20.9 | 33.3 |
| | strength | | | | | | | |
| | (Mpa) | | | | | | | |
| | Elongation | 150 | 140 | 140 | 145 | 165 | 185 | 260 |
| | (%) | | | | | | | |
| Volumetric | Polyalkylene | 6.1 | 5.8 | 5.7 | 5.4 | 5.3 | 5.1 | 4.4 |
| change | glycol (%) | | | | | | | |
| (%) | Mineral | 54.8 | 45.1 | 40.1 | 32.5 | 21.6 | 11.6 | 2.1 |
| | oil (%) | | | | | | | |
| Compression set (%) | | 19.8 | 21.4 | 24.5 | 28.1 | 35.2 | 37.1 | 42.2 |
| Blisters | Freon R- | ◯ | ◯ | ◯ | ◯ | Δ | × | × |
| | 134a | | | | | | | |
| | Freon R-12 | ◯ | ◯ | ◯ | ◯ | ◯ | ◯ | ◯ |

| | | | | | | | |
|---|---|---|---|---|---|---|---|
| Permeation amount of | 0.10 | 0.11 | 0.12 | 0.14 | 0.17 | 0.21 | 0.23 |
| Freon R-134a | | | | | | | |
| (mg/cm² · h) | | | | | | | |

◯: without blisters.
Δ: existence of blisters too small to be visually observed.
×: existence of blisters large enough to be visually observed.

Table 2 indicates evaluation results of the physical properties of rubber compositions different in a mixing ratio of EP rubber and hydrogenated NBR. It has been found that at mixing ratios within Examples 5 to 7, generation of blisters is not observed even if each of Freon R-12 and Freon R-134a is used, and that the swelling in contact with a mineral oil is lower than the target value (volumetric change not exceeded than 50%).

With regards to the permeation amount of Freon R-134a, compositions of the present invention have an apparent decrease, as compared with those of Comparative Examples.

The compositions of Comparative Examples 1 and 2 having a high hydrogenated NBR content have a high compression set (target: 40% or less), which is presumed to have a bad influence on the sealing life. In addition, blisters generate when Freon R-134a is used.

The composition of Present Example 1 having a greatly small content of hydrogenated NBR shows slightly marked swelling in contact with a mineral oil. Elongation and tensile strength of a molded rubber product of each of Present Examples are a little inferior to those of a molded product made of a composition (Comparative Example 1) containing only hydrogenated NBR, but they are within allowance as an EP rubber sealant.

TABLE 3

| | | Pres. | Pres. | Pres. | Pres. |
|---|---|---|---|---|---|
| | | Ex. 7 | Ex. 9 | Ex. 10 | Ex. 11 |
| Polymer | Hydrogenated | 40 | ← | ← | ← |
| | NBR (Wt. %) | | | | |
| | EPDM 1 (Wt. %) | 60 | — | — | — |
| | EPDM 2 (Wt. %) | — | 60 | — | — |
| | EPDM 3 (Wt. %) | — | — | 60 | — |
| | EPDM 4 (Wt. %) | — | — | — | 60 |
| Ordinary | Hardness (type A) | 83 | 81 | 82 | 82 |
| state | Tensile strength | 13.5 | 23.0 | 18.5 | 15.3 |
| | (MPa) | | | | |
| | Elongation (%) | 145 | 210 | 160 | 155 |

| Volumetric change (%) | 32.5 | 40.0 | 32.0 | 37.7 |
|---|---|---|---|---|
| Mineral oil | | | | |
| Compression set (%) | 28.1 | 35.5 | 28.0 | 30.4 |
| Blisters Freon R-12 | ◯ | × | ◯ | Δ |

◯: without blisters
Δ: existence of blisters too small to be visually observed
×: existence of blisters large enough to be visually observed

Table 3 shows evaluation results of the physical properties of rubber compositions which are different in the kind of EPDM. It has been found that the compositions of Present Examples 9 and 11, in which EPDM containing a smaller amount of a third component (diene:ethylidene norbornene, dicyclopentadiene) is added, generate blisters when Freon R-12 is used. Further, the rubber composition of Present Example 9, in which EPDM having a low Mooney viscosity is added, has a larger compression set, and is inferior in sealing life as compared with the other examples. These results suggest that EP rubber compositions having good physical properties are available when the Mooney viscosity is 50 or greater and a content of the third component is 5 wt. % or greater.

TABLE 4

| | | | Pres. | Pres. |
|---|---|---|---|---|
| | | | Ex. 7 | Ex. 12 |
| Polymer | | Hydrogenated NBR | 40 | 40 |
| | | (Wt. %) | | |
| | | EPDM1 (Et%) | 60 | 60 |
| Others | Filler | Carbon black | 40 | 40 |
| | | Silica | 21 | — |
| | | Talc | — | 70 |

| | | |
|---|---|---|
| Coupling agent | 1 | 1 |

| | | | |
|---|---|---|---|
| Ordinary | Hardness (type A) | 83 | 84 |
| State | Tensile strength (MPa) | 13.5 | 18.1 |
| | Elongation (%) | 145 | 125 |
| Volumetric | Polyalkylene glycol | 5.4 | 4.4 |
| change (%) | Mineral oil | 32.5 | 24.7 |

| | | |
|---|---|---|
| Compression set (%) | 28.1 | 31.7 |
| Permeation amount of Freon R-134a | 0.14 | 0.12 |
| (mg/cm2 · h) | | |

Table 4 shows an influence of the shape of a filler on physical properties. It has been found that the rubber composition of Present Example 12 containing a plate-like (biaxially oriented) filler (talc) is suppressed in swelling even if immersed in each of a mineral oil and a non-mineral oil and is superior in resistance against permeation of a freon gas as compared with the composition of the Present Example 7 containing spherical (non-oriented) silica. The composition of Present Example 12 is not so good in a compression set as that of Present Example 7, but it sufficiently is within a range permitting application as a sealant.

Physical properties in each of the above-described Tables are measured in accordance with the below-described testing methods.

Hardness: determined by a durometer hardness (Type A) test in accordance with JIS K 6253.

Tensile strength: determined by a tensile strength test in accordance with JIS K 6251.

Elongation: determined by a tensile elongation at break test in accordance with JIS K 6251.

Oil resistance test: Immersion Test was conducted in accordance with JIS K6258 and a volumetric change was determined. Immersion was conducted at 150° C. for 70 hours.

Compression set: Compression set of an O-ring having a wire diameter of ø 2.4 mm was determined by a compression set test in accordance with JIS K 6262. Compression was conducted under the conditions of 150° C.×70 hours at a compression ratio of 25%.

Generation of blisters: Generation of blisters for the O-ring was evaluated by immersion in a test liquid (freon) at 40° C. for 24 hours and then heat treating at 150° C. for 1 hour.

Permeation amount of freon gas: Gas permeation amount per unit hour and unit area at 40° C. was measured using an actual device.

The present invention is described with a case where a molded rubber product made of the EP rubber composition of the present invention is used as a sealing member for maintaining gas barrier properties against a freon refrigerant sealed in a refrigerator system. It is to be noted that the present invention is not limited to or by this case. For example, the EP rubber compositions of the present invention can be applied to molded rubber products such as diaphragm and hose.

Such changes and modifications are to be understood as being within the scope of the present invention as defined by the appended claims.

What is claimed is:

1. An ethylene-propylene copolymer rubber (EP rubber) composition usable as a molded rubber product having freon-gas barrier properties, wherein:
the EP rubber composition is an organic peroxide vulcanizable (crosslinkable) type having, as a base, a rubber polymer containing an EP rubber of an amount of at least 30 wt. % in the whole rubber polymer; and
the EP rubber has a Mooney viscosity (ML₁₊₄, 100° C.) of about 50 or greater.

2. The EP rubber composition of claim 1, wherein the Mooney viscosity (ML₁₊₄, 100° C.) of the EP rubber is about 55 or greater.

3. The EP rubber composition of claim 1, wherein the EP rubber is an EPDM containing at least about 5 wt. % of one of cyclopentadiene (DCPD) and ethylidene norbornene (ENB).

4. The EP rubber composition of claim 1, wherein the rubber polymer contains an NBR rubber, so that a weight ratio of NBR rubber/EP rubber is approximately in a range between 10/90 and 70/30.

5. The EP rubber composition of claim 4, wherein the weight ratio of NBR rubber/EP rubber is approximately in a range between 20/80 and 60/40.

6. The EP rubber composition of claim 1, wherein the rubber polymer contains a plate-like filler.

7. A sealing member used for a freon refrigerant cycle, the sealing member is made of an ethylene-propylene copolymer rubber (EP rubber) composition, wherein:
the EP rubber composition is an organic peroxide vulcanizable (crosslinkable) type having, as a base, a rubber polymer containing an EP rubber of an amount of at least 30 wt. % in the whole rubber polymer; and
the EP rubber has a Mooney viscosity (ML₁₊₄, 100° C.) of about 50 or greater.

8. The sealing member of claim 7, wherein the EP rubber is an EPDM containing at least about 5 wt. % of one of cyclopentadiene (DCPD) and ethylidene norbornene (ENB).

9. The sealing member of claim 7, wherein the rubber polymer contains an NBR rubber, so that a weight ratio of NBR rubber/EP rubber is approximately in a range between 10/90 and 70/30.
